(19) United States
(12) Patent Application Publication
(10) Pub. No.: US 2026/0328699 A1
(43) Pub. Date: Oct. 22, 2026

(54) INSPECTION SYSTEM FOR ELECTRODE SHEET AND INSPECTION METHOD FOR ELECTRODE SHEET USING SAME

(71) Applicant: SK On Co., Ltd., Seoul (KR)

(72) Inventors: Tae Kyu LEE, Daejeon (KR); Eun Taek OH, Daejeon (KR); Jung Soo CHANG, Daejeon (KR); Kyeung Su SHIN, Daejeon (KR); Ha Ran WON, Daejeon (KR); Dong Gyun KIM, Daejeon (KR); Jae Jun HONG, Daejeon (KR); Jeong Yeul LIM, Daejeon (KR)

(21) Appl. No.: 19/529,125

(22) Filed: Feb. 4, 2026

(30) Foreign Application Priority Data
Feb. 5, 2025 (KR) 10-2025-0014203
Sep. 17, 2025 (KR) 10-2025-0133527

(51) Int. Cl. G01N 21/88; G01N 21/95; H01M 4/62

(52) U.S. Cl. CPC G01N 21/8806; G01N 21/95; H01M 4/62; G01N 2201/062

(57) ABSTRACT

The present disclosure relates to an electrode sheet inspection system, including: a carrier that carries an electrode sheet having an insulating coating portion; a measurer that measures the insulating coating portion of the electrode sheet; and a controller that analyzes an image carried from the measurer, wherein the measurer comprises: first and second lighters provided on the upper side of the electrode sheet and irradiating light onto the electrode sheet; a third lighter provided adjacent to a side of the electrode sheet and irradiating light onto the electrode sheet; and an imager provided on the upper side of the electrode sheet and imaging the electrode sheet and transmitting the image to the controller.

### CROSS-REFERENCE TO RELATED PATENT APPLICATION

The present application claims priority under 35 U.S.C. § 119(a) to Korean patent application number 10-2025-0014203 filed on Feb. 5, 2025 and Korean patent application number 10-2025-0133527 filed on Sep. 17, 2025, in the Ministry of Intellectual Property, the entire disclosure of which is incorporated by reference herein.

### BACKGROUND OF THE INVENTION

### 1. Field

The present disclosure relates to an electrode sheet inspection system and an electrode sheet inspection method using the same.

### 2. Description of the Related Art

Secondary batteries, unlike primary batteries, are increasingly in demand due to their rechargeability, compactness, and large capacity. These secondary batteries are manufactured in the form of a single battery cell packed in a pack or a battery pack composed of dozens of connected battery cells, and are widely used as a power source for cell phones, laptops, and motors in electric vehicles.

Various research efforts are underway to manufacture these battery cells with uniform quality and high productivity. In particular, in the manufacturing process of battery cells, electrode sheets used as a positive electrode or a negative electrode are mainly processed in an in-line process, and it is necessary to reduce inefficiency due to process stoppage, maintenance, etc. due to defect detection and defect treatment of electrode sheets during the in-line process.

### SUMMARY OF THE INVENTION

An embodiment of the present disclosure may provide an electrode sheet inspection system enabling to improve the process efficiency of a battery cell, and an electrode sheet inspection method using the same.

Furthermore, an embodiment of the present disclosure may provide an electrode sheet inspection system enabling to efficiently address defects in electrode sheets undergoing in-line processing, and an electrode sheet inspection method using the same.

Meanwhile, the present disclosure may be widely applied to green technology fields such as electric vehicles, battery charging stations, energy storage systems (ESS), and other battery-based photovoltaics and wind power. Furthermore, the present disclosure may be used in eco-friendly mobility, including electric vehicles and hybrid vehicles, to prevent climate change by reducing air pollution and greenhouse gas emissions.

An embodiment of the present disclosure includes an electrode sheet inspection system and an electrode sheet inspection method using the same.

In an embodiment, the electrode sheet inspection system may include: a carrier that carries an electrode sheet having an insulating coating portion; a measurer that measures the insulating coating portion of the electrode sheet; and a controller that analyzes an image carried from the measurer, wherein the measurer includes: first and second lighters provided on the upper side of the electrode sheet and irradiating light onto the electrode sheet; a third lighter provided adjacent to a side of the electrode sheet and irradiating light onto the electrode sheet; and an imager provided on the upper side of the electrode sheet and imaging the electrode sheet and transmitting the image to the controller.

In an embodiment, the first lighter may include a white LED having a wavelength of 380 nm to 760 nm, and the second and third lighters each may include a blue LED having a wavelength of 350 nm to 495 nm.

In an embodiment, the first lighter may be spaced apart from the electrode sheet by a first distance of 90 mm to 1100 mm and irradiate the light at a first angle of 70 ° to 95 ° with respect to the electrode sheet, the second lighter may be spaced apart from the electrode sheet by a second distance of 90 mm to 1100 mm and irradiate the light at a second angle of 75 ° to 95 ° with respect to the electrode sheet, and the third lighter may be spaced apart from the electrode sheet by a third distance of 70 mm to 130 mm and irradiate the light at a third angle of 10 ° to 30 ° with respect to the electrode sheet.

In an embodiment, the imager is provided at a fourth angle of 40 ° to 65 ° with respect to the electrode sheet, and an image is acquired by light irradiated by each of the first to third lighters.

In an embodiment, the electrode sheet inspection system may further include an electrode sheet meandering detector provided at the front end of the measurer with respect to the carrying path of the electrode sheet.

In an embodiment, the electrode sheet meandering detector may include a detection sensor that measures a carrying path of the electrode sheet, wherein when deviating from a pre-input range by a first distance, the carrying path measured by the detection sensor is transmitted to the controller, and the controller adjusts the position of at least one of the first, second, or third lighters and the imager according to information transmitted from the electrode sheet meandering detector.

In an embodiment, wherein the controller analyzes the image transmitted from the measurer to measure at least one of the thickness or width of the insulating coating portion to determine whether there is a defect.

In an embodiment, the electrode sheet inspection system may further include a defect position displayer installed after the measurer with respect to the carrying path of the electrode sheet.

In an embodiment, if the controller determines that at least one of the thickness or width of the insulating coating portion is defective, the controller transmits the at least one to the defect position displayer, the defect position displayer includes an ink marker, and the defect position displayer uses the ink marker to mark the electrode sheet.

In an embodiment, the electrode sheet may include: a metal sheet; a coating portion formed on at least one of one or both surfaces of the metal sheet; a non-coating portion where the metal sheet is exposed without the coating portion; and an insulating coating portion provided at a boundary between the coating portion and the non-coating portion to cover at least a portion of the coating portion, wherein the electrode sheet inspection system determines whether the insulating coating portion is defective.

In an embodiment, the method of inspecting an electrode sheet may include: performing insulating coating measurement step, in which an electrode sheet is carries while being equipped with an insulating coating portion, and the insulating coating portion of the electrode sheet is measured using a measurer to obtain an image; and performing an insulating coating determination step, in which the image is analyzed to determine whether the insulating coating portion is defective, wherein the measurer includes: first and second lighters provided on the upper side of the electrode sheet and irradiating light onto the electrode sheet; a third lighter provided adjacent to a side of the electrode sheet and irradiating light onto the electrode sheet; and an imager provided on the upper side of the electrode sheet and imaging the electrode sheet and transmitting the image to the controller.

In an embodiment, the imager may be provided at an angle of 40 ° to 65 ° with respect to the electrode sheet, and acquire an image by light irradiated by each of the first to third lighters.

In an embodiment, the method may further include, prior to the performing of the insulating coating measurement step, performing electrode sheet path detection step in which the carrying path of the electrode sheet is measured, wherein the electrode sheet path detection step includes measuring the carrying path of the electrode sheet using a detection sensor, and transmitting to a controller if the carrying path measured by the detection sensor deviates from a pre-input range by a first distance, wherein the controller adjusts the position of at least one of the first, second, or third lighters and the imager.

In an embodiment, the method may further include, after the performing of the insulating coating determination step, performing defect position display step in which the bonding position of the electrode sheet is displayed, wherein the defect position display step includes displaying the defect position on the electrode sheet if the insulating coating portion is determined to be defective in the insulating coating determination step.

In an embodiment, the method may further include performing electrode sheet path detection step in which the carrying path of the electrode sheet is measured before the insulating coating measurement step; and performing defect position display step in which the bonding position of the electrode sheet is indicated after the insulating coating determination step, wherein the electrode sheet path detection step, the insulating coating measurement step, the insulating coating determination step, and the defect position display step are performed in-line.

According to an embodiment of the present disclosure, an electrode sheet inspection system that can improve the process efficiency of battery cells, and an electrode sheet inspection method using the same may be provided.

Furthermore, according to an embodiment of the present disclosure, an electrode sheet inspection system that can efficiently address defects in electrode sheets undergoing in-line processing, and an electrode sheet inspection method using the same may be provided.

### BRIEF DESCRIPTION OF THE DRAWINGS

FIG. 1 is a schematic view illustrating an electrode sheet inspection system according to an embodiment of the present disclosure.

FIG. 2 is a side view illustrating an electrode sheet inspection using an electrode sheet inspection system of FIG. 1.

FIG. 3 is a front view illustrating an electrode sheet inspection using an electrode sheet inspection system of FIG. 1.

FIG. 4 is a view illustrating an electrode sheet according to an embodiment of the present disclosure.

FIG. 5 is a view illustrating the inspection of an insulating coating portion on an electrode sheet.

FIG. 6 is a view illustrating the operation of a third lighter of FIG. 1.

FIG. 7 is a schematic view illustrating an electrode sheet inspection system according to another embodiment of the present disclosure.

FIG. 8 is a flowchart illustrating an electrode sheet inspection method according to another embodiment of the present disclosure.

### DETAILED DESCRIPTION

The structural or functional descriptions of embodiments disclosed in this specification or application are illustrated for the purpose of describing embodiments in accordance with the technical ideas of the present disclosure only, and embodiments in accordance with the technical ideas of the present disclosure may be practiced in various forms other than those disclosed in this specification or application, and the technical ideas of the present disclosure shall not be construed to be limited to the embodiments described in this specification or application.

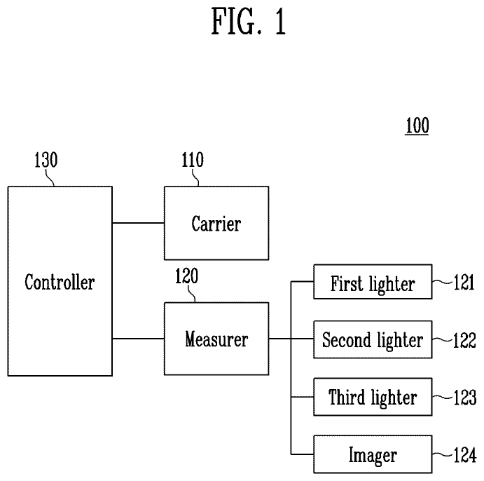

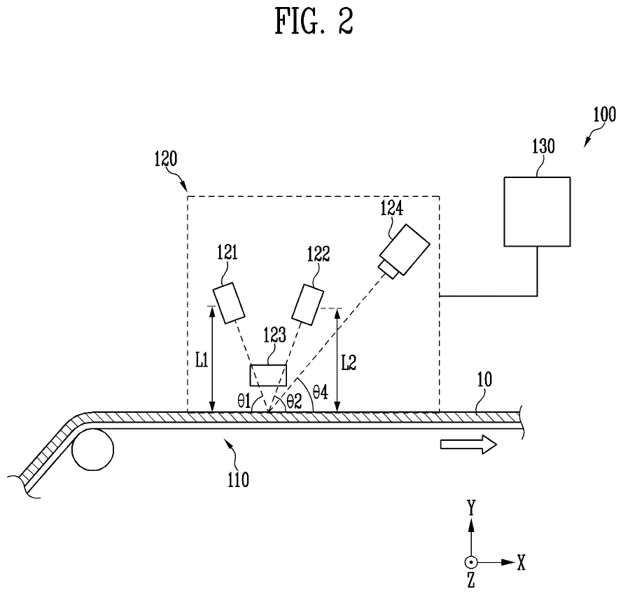

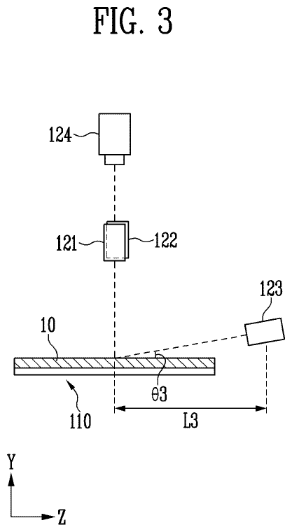

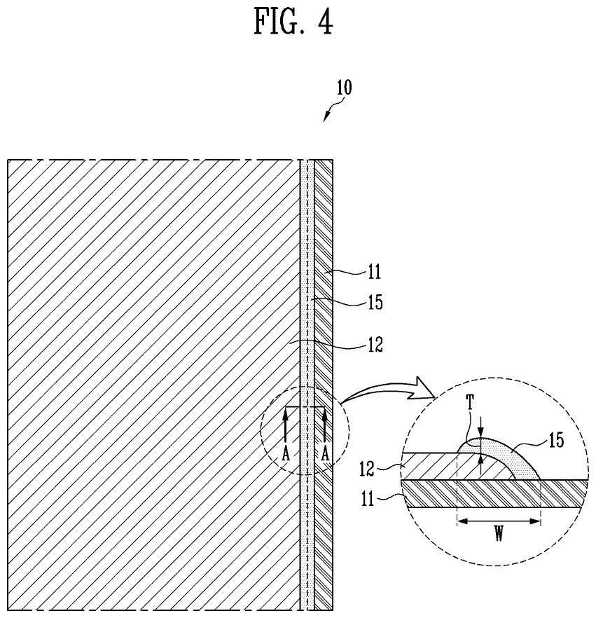

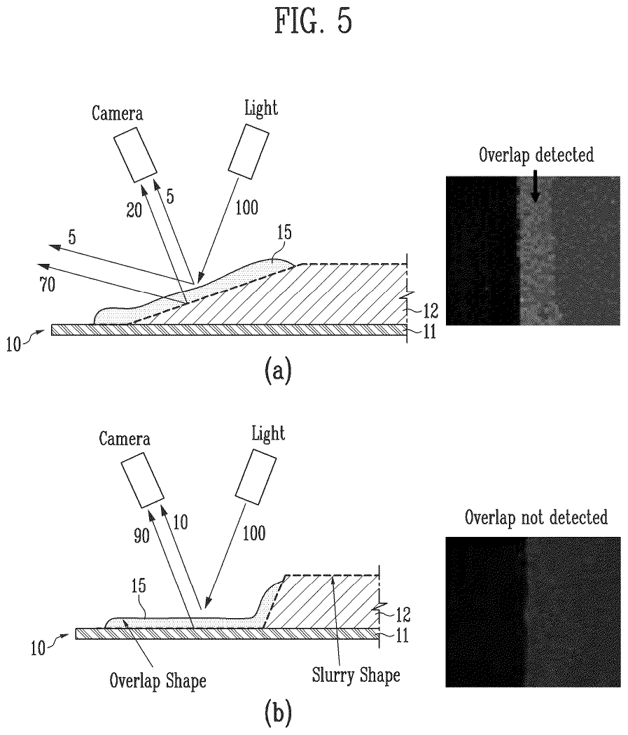

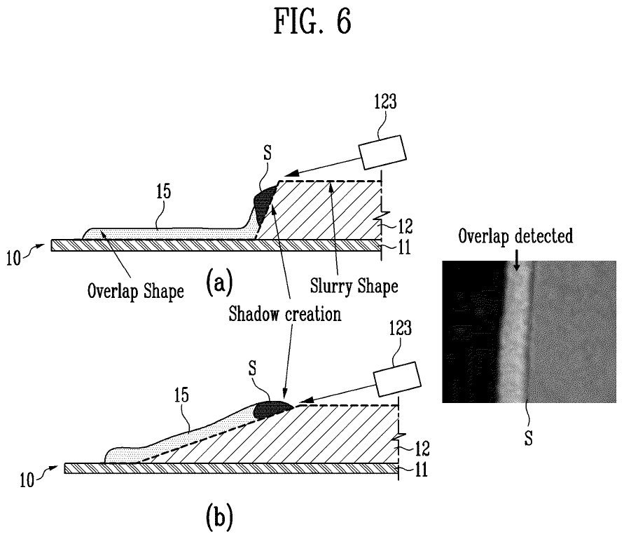

FIG. 1 is a schematic view illustrating an electrode sheet inspection system according to an embodiment of the present disclosure. FIG. 2 is a side view illustrating an electrode sheet inspection using an electrode sheet inspection system of FIG. 1. FIG. 3 is a front view illustrating an electrode sheet inspection using an electrode sheet inspection system of FIG. 1. FIG. 4 is a view illustrating an electrode sheet according to an embodiment of the present disclosure. FIG. 5 is a view illustrating the inspection of an insulating coating portion on an electrode sheet. FIG. 6 is a view illustrating the operation of a third lighter of FIG. 1.

Referring to FIG. 1, an electrode sheet inspection system 100 according to an embodiment of the present disclosure may include a carrier 110 that transfers an electrode sheet 10 having an insulating coating portion; a measurer 120 that measures the insulating coating portion of the electrode sheet 10; and a controller 130 that analyzes an image transmitted from the measurer 120. Furthermore, the measurer 120 may include first and second lighters 121, 122 provided on the upper side of the electrode sheet 10 to irradiate light onto the electrode sheet 10; third lighters 123 provided adjacent to a side of the electrode sheet 10 to irradiate light onto the electrode sheet 10; and an imager 124 provided on the upper side of the electrode sheet 10 to image the electrode sheet 10 and transmit the image to the controller 130.

Typically, during the manufacturing process of secondary batteries, electrode sheets, such as positive and negative electrodes, are carried, and defects in the electrode sheets are measured and detected during the carrying process. At this time, the electrode sheets are carried at a predetermined speed using a roll-to-roll process, etc. However, during the process of photographing the electrode sheets and detecting defects, the transport speed of the electrode sheets must be reduced to ensure accurate defect detection, which can reduce productivity. Furthermore, disadvantageously, defect detection has been hampered by light reflection, which occurs due to the materials constituting the electrode sheets being metal and positive or negative active materials.

In contrast, the electrode sheet inspection system 100 according to an embodiment of the present disclosure utilizes a novel configuration to effectively detect defects in electrode sheets transported at a predetermined speed. Furthermore, the electrode sheet inspection system 100 according to an embodiment of the present disclosure may effectively detect defects in the insulating coating portion, which occupies a very small area of the electrode sheet 10, regardless of the slope, size, or shape of the insulating coating portion. The electrode sheet inspection system 100 according to an embodiment of the present disclosure may effectively and accurately detect defects in the insulating coating portion of an electrode sheet, thereby reducing unnecessary electrode sheet loss and effectively improving productivity.

The carrier 110 may carry the electrode sheet 10. The electrode sheet 10 may be provided in a sheet shape extending in one direction. The carrier 110 carries the electrode sheet and may include a roll-to-roll device or a conveyor device. The carrier 110 may carry the electrode sheet at a first speed.

The measurer 120 may measure the electrode sheet 10 carried at the first speed by the carrier 110. Specifically, the measurer 120 may measure the insulating coating portion of the electrode sheet 10.

The measurer 120 may include first to third lighters 121, 122, 123 and an imager 124. The first to third lighters 121, 122, 123 may irradiate light at various angles to the electrode sheet 10, and the imager 124 may image the electrode sheet 10 using the light irradiated and reflected by the electrode sheet 10 to create an image.

Referring to FIGS. 2 to 4, the first lighters 121 and the second lighters 122 are provided on the upper side of the electrode sheet 10 and may irradiate light onto the electrode sheet 10. The first and second lighters 121, 122 are provided with different wavelengths and may irradiate light onto the electrode sheet 10 at different angles. The third lighters 123 are provided adjacent to the side of the electrode sheet 10 and may irradiate light onto the electrode sheet 10. Furthermore, the first and second lighters 121, 122 provided on the upper side of the electrode sheet 10 may be provided with different wavelengths.

As described above, the electrode sheet inspection system 100 according to the embodiment of the present disclosure irradiates light to the electrode sheet 10 at different positions and with different wavelength ranges for each position, and this allows the light applied by the first to third lighters 121, 122, 123 to interact with each other, enabling more accurate measurement of the thickness, width, and length of the insulating coating portion 15 of the electrode sheet 10.

The electrode sheet 10 may include a metal sheet 11 made of metal or the like, a coating portion 12 formed on at least one of one or both surfaces of the metal sheet 11, and a non-coating portion which is a portion of the metal sheet exposed because the coating portion 12 is not provided. The coating portion 12 may include a region on the metal sheet 11 where an active material, such as a positive electrode active material or an negative electrode active material, is provided, and the non-coating portion may be a portion of the metal sheet 11 that is exposed as is. The insulating coating portion 15 may be provided to cover at least a portion of the coating portion 12 at the boundary between the coating portion 12 and the non-coating portion. The electrode sheet inspection system 100 according to the present embodiment may determine whether the insulating coating portion 15 is defective.

The coating portion 12 may be formed by preparing the active material as a slurry and coating the slurry onto the metal sheet 11. The slurry may include a solvent and an active material, and may be formed by coating the slurry onto the metal sheet 11 and then drying the solvent. The slurry may be provided in a form with a predetermined viscosity, so that edge taper phenomena, etc., may occur during the process of forming the coating portion 12. Specifically, the end of the coating portion 12, which is the starting or ending point between the coating portion 12 and the non-coating portion, may be inclined due to the slurry being dragged by the frictional force between the coating portion 12 and the metal sheet 11.

The insulating coating portion 15 may be provided at the boundary between the coating portion 12 and the non-coating portion, thereby covering the end of the coating portion 12. At this time, the end of the coating portion 12 may be inclined at various angles depending on material properties, such as the viscosity of the slurry and the surface contact angle of the metal sheet, as well as methodological properties, such as the coating method and drying method. The insulating coating portion 15 is formed according to the shape of the inclination of the coating portion 12, and as a result, the height, thickness, and width of the coating portion 12 may be affected by the inclination of the coating portion 12.

The insulating coating portion 15 may be made of an insulating material. The insulating coating portion 15 may cover the end of the coating portion 12, thereby preventing stability issues in the secondary battery that may arise due to the detachment of the coating portion 12.

The insulating coating portion 15 may be provided at a predetermined average thickness T on the coating portion 12. The average thickness T of the insulating coating portion 15 may range from 3 μm to 50 μm. If the average thickness T of the insulating coating portion 15 is less than 3 μm, it may be difficult to uniformly coat the coating portion 12, and defects such as the coating portion 12 being exposed during the production process may occur. Additionally, if the average thickness T of the insulating coating portion 15 exceeds 50 μm, the portion of the insulating coating portion 15 is too thick, making it difficult to properly align the electrode sheet 10 during lamination. Specifically, the average thickness T of the insulating coating portion 15 may range from 3 μm to 40 μm, or from 3 μm to 30 μm, or from 5 μm to 20 μm, or from 5 μm to 10 μm.

The insulating coating portion 15 may be formed by connecting the non-coating portion to the end of the coating portion 12. The width W of the insulating coating portion 15 may range from 5 mm to 30 mm. If the width W of the insulating coating portion 15 is less than 5 mm, it may be difficult to stably secure the end of the coating portion 12, which may degrade the insulation properties. If the width W of the insulating coating portion 15 exceeds 30 mm, the area within the electrode sheet 10 where lithium ion movement is restricted increases, which may reduce the volumetric capacity efficiency of the secondary battery. Specifically, the width W of the insulating coating portion 15 may range from 3 mm to 25 mm, or from 3 mm to 20 mm, or from 5 mm to 15 mm, or from 5 mm to 10 mm.

Conventionally, when identifying defects in the insulating coating portion, it has been difficult to accurately measure the thickness or width of the insulating coating portion due to factors such as the degree of inclination of the end of the coating portion provided beneath the insulating coating portion and the resulting light reflection. This issue will be described in detail with reference to FIG. 5.

In the case of (a) of FIG. 5, when the coating portion 12 on the electrode sheet 10 is gently sloped over the metal sheet 11, the insulating coating portion 15 is covered along the slope of the coating portion 12, and the overlap of the insulating coating portion 15 may be detected using a camera or the like, allowing the thickness, width, and length of the insulating coating portion 15 to be confirmed. Specifically, assuming 100% of the light emitted by the light source light, 70% of the light is reflected by the slope of the coating portion 12, and 5% of the light is reflected by the insulating coating portion 15. At this time, 20% of the light is transmitted to the camera by the coating portion 12, and 5% of the light is transmitted by the insulating coating portion 15 to form an image. The presence or absence of defects in the insulating coating portion 15 may be determined based on the image obtained by the camera.

On the other hand, as in the case of (b) of FIG. 5, when the slurry is formed with a steep slope and the coating portion 12 is steep, it is difficult to detect the overlapping portion using the camera, resulting in difficulty in determining whether the insulating coating portion 15 is defective. Specifically, even if the light source illuminates at 100% light, the camera receives 90% of the light from the coating portion 12 and 10% of the light from the insulating coating portion 12 due to the slope of the coating portion 12. Since most of the information received by the camera is light reflection from the coating portion 12, the visibility of the insulating coating portion 15 is reduced, making it difficult to determine whether the insulating coating portion 12 is defective.

In contrast, the electrode sheet inspection system 100 according to an embodiment of the present disclosure includes the first to third lighters 121, 122, 123 and the imager 124, and may effectively detect defects in the insulating coating portion 12 regardless of the degree of inclination of the coating portion 12 using the first to third lighters 121, 122, 123 and the imager 124.

The first lighter 121 may include a white LED with a wavelength of 380 nm to 760 nm, and the second and third lighters 122, 123 may each include a blue LED with a wavelength of 350 nm to 495 nm.

The first lighter 121 and the second lighter 122 provided on the upper portion of the electrode sheet 10 have different wavelengths within the aforementioned range, thereby applying light of a composite wavelength from the upper portion of the electrode sheet 10, thereby improving the visibility of the insulating coating portion 15 from the upper portion of the electrode sheet 10.

The light applied from the second lighter 122 has a different wavelength from the light applied from the first lighters 121, thereby forming a composite wavelength from the upper portion of the electrode sheet 10. Specifically, the light from the second lighters 122 may have a lower wavelength than the light from the first lighter 121.

The third lighter 123 may apply light to the electrode sheet 10 from the side surface. If the wavelength of the third lighter 123 is less than 350 nm, the visibility of the insulating coating portion 15 is reduced due to side light reflection from the electrode sheet 10. If the wavelength exceeds 435 nm, the imager 124 cannot effectively receive the light transmitted by the third lighters 123, which is problematic.

The first lighter 121 is spaced from the electrode sheet 10 by a first distance L1 of 90 mm to 1100 mm and may irradiate the light at a first angle θ1 of 70 ° to 95 ° with respect to the electrode sheet 10.

The first lighter 121 is provided on top of the electrode sheet 10 and may inspect for defects in the coating portion 12 and the insulating coating portion 15. The first lighter 121 may irradiate light from the non-coating portion above the electrode sheet 10 toward the coating portion 12. The first lighters 121 may change the angle within a first angle θ1 to check for defects in the insulating coating portion 15 and the coating portion 12, such as pinholes or bubbles. The first lighter 121 maintains the first distance L1 and first angle θ1, and thus it is possible to improve the visibility of the coating portion 12 and the insulating coating portion 15 from above the electrode sheet 10.

The second lighter 122 is spaced from the electrode sheet 10 by a second distance L2 of 90 mm to 1100 mm and may irradiate light at a second angle θ2 of 75 ° to 95 ° with respect to the electrode sheet.

The second lighters 122 may inspect the insulating coating portion 15 for defects from above the electrode sheet 10. The second lighters 122 may irradiate light from above the electrode sheet 10 in a direction from the coating portion 12 toward the non-coating portion. Specifically, the second lighter 122 is positioned at the second angle θ2, thereby improving the detection capability of the thickness, width, length, etc. of the insulating coating portion 15 by irradiating light. The second lighter 122 maintains the second distance L2 and the second angle θ2, thereby forming a composite wavelength with the first lighter 121 above the electrode sheet 10, thereby improving the visibility of the insulating coating portion 15.

The third lighter 123 is spaced apart from the electrode sheet 10 by a third distance L3 of 70 mm to 130 mm, and may irradiate light at a third angle θ3 of 10 ° to 30 ° with respect to the electrode sheet 10.

Referring to FIG. 6, the third lighter 123 is provided spaced apart from the side of the electrode sheet 10, thereby forming a shadow S at the boundary of the insulating coating 15.

As shown in (a) of FIG. 6, when the coating portion 12 formed on the metal sheet 11 of the electrode sheet 10 is steeply inclined, the third lighter 123 may form a shadow S at the point where the slope of the insulating coating portion 15 begins. Furthermore, as shown in (b) of FIG. 6, when the coating portion 12 formed on the metal sheet 11 of the electrode sheet 10 is gently inclined, the third lighters 123 may form a shadow S at the point where the slope of the insulating coating portion 15 begins. That is, the third lighter 123 is positioned adjacent to the side of the electrode sheet 10 to form a shadow S at the point where the slope of the insulating coating portion 15 begins, thereby effectively detecting the overlapping portion of the insulating coating portion 15.

The electrode sheet inspection system 100 according to the present embodiment can effectively detect the thickness or width of the insulating coating portion 15 by controlling the arrangement, angle, and distance of the first to third lighters 121, 122, 123 relative to the electrode sheet 10. Furthermore, by controlling the light irradiated from the first to third lighters 121, 122, 123, each light can be efficiently applied to the electrode sheet 10, thereby securing an image with improved visibility of the thickness or width of the insulating coating portion 15 using the imager 124.

The imager 124 may be provided at a fourth angle θ4 of 40 ° to 65 ° with respect to the electrode sheet 10, enabling the acquisition of an image using the light irradiated by each of the first to third lighters 121, 122, 123. The imager 124 may determine the thickness or width of the insulating coating portion 15 by detecting light emitted from the first to third lighters 121, 122, 123 and reflected from the insulating coating portion 15.

The imager 124 may include, but is not limited to, a line scan camera. Furthermore, the imager 124 may acquire images by wavelength, and the resolution of the imager 124 may be less than 25 μm.

The imager 124 may acquire an image including the insulating coating portion 15. In the image, the insulating coating portion 15 may be distinguished by color, contrast, saturation, etc. For example, in the image, the insulating coating portion 15 may be expressed in a lighter gray than its surroundings, and its visibility may be enhanced by the shadow S (see FIG. 6) created by the third lighter 123.

The imager 124 may be provided at the fourth angle θ4, and by positioning the imager 124 at the aforementioned angle, it efficiently receives light from the first to third lighters 121, 122, 123, further enhancing the visibility of the insulating coating portion 15 within the image.

The controller 130 may analyze the image transmitted from the measurer 120 and measure at least one of the thickness or width of the insulating coating portion 15 to determine whether it is defective. The controller 130 may acquire individual images from the first to third lighters 121, 122, 123 using multi-line shots, etc. Furthermore, the controller 130 may set a Sub-Region of Interest (Sub-ROI) and generate a profile within the ROI to extract the edge portion. The controller 130 may determine whether at least one of the thickness or width of the insulating coating portion 15 falls within the pre-stored data range (OK) or falls outside the pre-stored data range (NG).

The image may be provided in various forms, such as a video or image, and the controller 130 may use various schemes to determine whether the insulating coating portion 15 is defective, and is not limited to the aforementioned methods.

The electrode sheet inspection system according to an embodiment of the present disclosure may assess the presence of defects in the insulating coating portion of an electrode sheet with high accuracy, which is difficult to inspect using existing vision systems.

Furthermore, the electrode sheet inspection system according to an embodiment of the present disclosure can effectively screen for defects in the electrode sheet by improving the visibility of the insulating coating portion, regardless of the degree of inclination of the coating portion on the electrode sheet.

Furthermore, the electrode sheet inspection system according to an embodiment of the present disclosure can reduce loss and improve the electrode sheet manufacturing yield by accurately inspecting the insulating coating portion of an electrode sheet for defects.

Furthermore, the electrode sheet inspection system according to the embodiment of the present disclosure may be applied to secondary battery assembly processes and electrode manufacturing processes, thereby improving process yield and productivity.

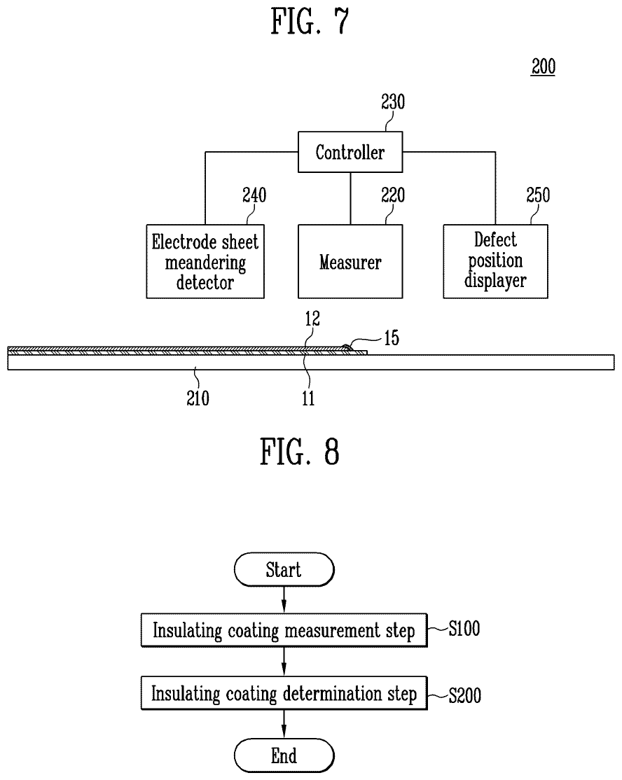

Hereinafter, another embodiment of the present disclosure will be described with reference to FIGS. 7 and 8. In the following embodiment, any components that overlap with those described in FIGS. 1 to 6 will be omitted for brevity.

FIG. 7 is a schematic view illustrating an electrode sheet inspection system according to another embodiment of the present disclosure.

Referring to FIG. 7, the electrode sheet inspection system 200 according to the present embodiment may include a carrier 210 for carrying the electrode sheet, a measurer 220 for measuring the electrode sheet, a controller 230 for receiving images from the measurer 220, an electrode sheet meandering detector 240, and a defect position displayer 250.

The electrode sheet may include a metal sheet 11, a coating portion 12 formed by coating slurry on the metal sheet 11, and an insulating coating portion 15 made of an insulating material covering the end of the coating portion 12. The electrode sheet inspection system 200 according to the present embodiment can detect defects in the insulating coating portion 15 on the carried electrode sheet with high accuracy. Additionally, the electrode sheet meandering detector 240 controls the carrying path of the electrode sheet, and the defect position displayer 250 may display a defect in the insulating coating portion 15 if one is detected.

The measurer 220 may include first and second lighters that apply light to the electrode sheet, and an imager that acquires an image of the insulating coating portion 15 using the light.

The electrode sheet meandering detector 240 may be provided at the front end of the measurer 220 with respect to the carrying path of the electrode sheet.

The electrode sheet meandering detector 240 may include a detection sensor that measures the carrying path of the electrode sheet. The electrode sheet meandering detector 240 may transmit an error to the controller 230 if the carrying path measured by the detection sensor deviates from a pre-input range by a first distance. The controller 230 may adjust the position of one or more of the first to third lighters and the imager based on information transmitted from the electrode sheet meandering detector 240.

For example, the electrode sheet meandering detector 240 may transmit information to the controller 230 when the first distance is 3 mm or greater. If the carrying path of the electrode sheet deviates from the first distance, the reflection path of the light applied from the first to third lighters changes, resulting in a decrease in the visibility of the insulating coating portion 15.

Accordingly, the electrode sheet meandering detector 240 is installed before the measurer 220 to check the carrying path of the electrode sheet and transmit this information to the controller 230, thereby controlling the angle, position, etc., of at least one of the first, second, or third lighters and the imager.

The electrode sheet meandering detector 240 checks the carrying path of the electrode sheet before the measurer 220, thereby controlling the influence of the carrying path of the electrode sheet on defect detection of the insulating coating portion 15.

The defect position displayer 250 may be installed after the measurer 220 with respect to the carrying path of the electrode sheet. If the controller 230 determines that at least one of the thickness or width of the insulating coating portion 15 is defective, the controller 230 may transmit this information to the defect position displayer 250.

The defect position displayer 250 may include an ink marker. The defect position displayer 250 may use the ink marker to mark the electrode sheet.

The defect position displayer 250 displays only the defective portion of the insulating coating portion 15, thereby enabling selective removal of only the defective portion of the insulating coating portion 15. Therefore, unlike conventional methods, instead of discarding the entire batch of electrode sheets, a portion of the electrode sheets is selected to distinguish between good and defective products, thereby improving the productivity of secondary batteries. Furthermore, the defect position displayer 250 allows identification of defective portions of the insulating coating portion 15 within the electrode sheets, enabling effective analysis and feedback on their impact on the process.

FIG. 8 is a flowchart illustrating an electrode sheet inspection method according to another embodiment of the present disclosure.

Referring to FIG. 8, the electrode sheet inspection method according to the present embodiment may include insulating coating measurement step S100 of carrying an electrode sheet equipped with an insulating coating portion and measuring the insulating coating portion of the electrode sheet using a measurer to obtain an image; and insulating coating determination step S200 of analyzing the image to determine whether the insulating coating portion is defective.

The measurer may include first and second lighters provided above the electrode sheet and irradiating light onto the electrode sheet; a third lighter provided adjacent to a side of the electrode sheet and irradiating light onto the electrode sheet; and an imager provided above the electrode sheet and imaging the electrode sheet and transmitting the image to the controller.

In the insulating coating measurement step S100, the imager may generate an image using the light applied by the first to third lighters. The image may be transmitted to the controller.

In the insulating coating measurement step S100, the electrode sheet may be moved at a constant speed while simultaneously measuring the insulating coating portion using the measurer. The insulating coating measurement step S100 may measure the insulating coating portion without stopping the progress of the electrode sheet, thereby improving process efficiency.

The imager is provided at an angle of 40 ° to 65 ° with respect to the electrode sheet and may image an image using light irradiated by each of the first to third lighters.

In the insulating coating determination step S200, the controller may determine whether the insulating coating portion is defective by evaluating the image.

Prior to the insulating coating measurement step, the method may further include electrode sheet path detection step of measuring the carrying path of the electrode sheet. The electrode sheet path detection step may measure the carrying path of the electrode sheet using a detection sensor. If the carrying path measured by the detection sensor deviates from the pre-input range by a first distance, the controller may transmit the information, and the controller may adjust the position of one or more of the first to third lighters and the imager.

By measuring the carrying path of the electrode sheet and transmitting the information to the controller prior to the insulating coating measurement step, the presence or absence of a defect in the insulating coating portion may be effectively determined.

After the insulating coating determination step, defect position display step may further be included to indicate the joining position of the electrode sheet. The defect position display step may indicate the defective portion of the electrode sheet if the insulating coating portion is determined to be defective in the insulating coating determination step. By marking the portion of the electrode sheet where the insulating coating portion is defective, for example, using an ink marker, the defective portion can be effectively identified and controlled.

An electrode sheet inspection method according to an embodiment of the present disclosure may further include: electrode sheet path detection step of measuring the carrying path of the electrode sheet prior to the insulating coating measurement step; and defect position display step of indicating the joining position of the electrode sheet after the insulating coating determination step. The electrode sheet path detection step, insulating coating measurement step, insulating coating determination step, and defect position display step may be performed in-line.

The electrode sheet inspection method may determine whether the insulating coating portion of the electrode sheet is defective with high accuracy, and the electrode sheet path detection step can improve the accuracy of the insulation coating portion defect measurement. Furthermore, by further including a defect position display step, the defective portion of the electrode sheet may be easily identified, thereby improving productivity.

One having ordinary knowledge in the technical field to which the present disclosure belongs will understand that the present disclosure may be practiced in other specific forms without altering its technical ideas or essential features. It should therefore be understood that the embodiments described above are exemplary in all respects and are not intended to be limiting. The scope of the present disclosure is indicated by the scope of the following patent claims rather than by the detailed description above, and the meaning and scope of the claims and all modifications or variations derived from the equivalents thereof should be construed to be included within the scope of the present disclosure.

What is claimed is:

1. An electrode sheet inspection system, comprising:
a carrier that carries an electrode sheet having an insulating coating portion;
a measurer that measures the insulating coating portion of the electrode sheet; and
a controller that analyzes an image carried from the measurer, wherein the measurer comprises:
first and second lighters provided on the upper side of the electrode sheet and irradiating light onto the electrode sheet;
a third lighter provided adjacent to a side of the electrode sheet and irradiating light onto the electrode sheet; and
an imager provided on the upper side of the electrode sheet and imaging the electrode sheet and transmitting the image to the controller.

2. The electrode sheet inspection system of claim 1,
wherein the first lighter includes a white LED having a wavelength of 380 nm to 760 nm, and
wherein the second and third lighters each include a blue LED having a wavelength of 350 nm to 495 nm.

3. The electrode sheet inspection system of claim 1,
wherein the first lighter is spaced apart from the electrode sheet by a first distance of 90 mm to 1100 mm and irradiate the light at a first angle of 70 ° to 95 ° with respect to the electrode sheet,
wherein the second lighter is spaced apart from the electrode sheet by a second distance of 90 mm to 1100 mm and irradiate the light at a second angle of 75 ° to 95 ° with respect to the electrode sheet,
wherein the third lighter is spaced apart from the electrode sheet by a third distance of 70 mm to 130 mm and irradiate the light at a third angle of 10 ° to 30 ° with respect to the electrode sheet.

4. The electrode sheet inspection system of claim 1,
wherein the imager is provided at a fourth angle of 40 ° to 65 ° with respect to the electrode sheet, and
wherein an image is acquired by light irradiated by each of the first to third lighters.

5. The electrode sheet inspection system of claim 1,
further comprising an electrode sheet meandering detector provided at the front end of the measurer with respect to the carrying path of the electrode sheet.

6. The electrode sheet inspection system of claim 5,
wherein the electrode sheet meandering detector comprises a detection sensor that measures a carrying path of the electrode sheet,
wherein when deviating from a pre-input range by a first distance, the carrying path measured by the detection sensor is transmitted to the controller, and
wherein the controller adjusts the position of at least one of the first, second, or third lighters and the imager according to information transmitted from the electrode sheet meandering detector.

7. The electrode sheet inspection system of claim 1,
wherein the controller analyzes the image transmitted from the measurer to measure at least one of the thickness or width of the insulating coating portion to determine whether there is a defect.

8. The electrode sheet inspection system of claim 7,
further comprising a defect position displayer installed after the measurer with respect to the carrying path of the electrode sheet.

9. The electrode sheet inspection system of claim 8,
wherein if the controller determines that at least one of the thickness or width of the insulating coating portion is defective, the controller transmits the at least one to the defect position displayer,
wherein the defect position displayer includes an ink marker, and
wherein the defect position displayer uses the ink marker to mark the electrode sheet.

10. The electrode sheet inspection system of claim 1,
wherein the electrode sheet comprises:
a metal sheet;
a coating portion formed on at least one of one or both surfaces of the metal sheet;
a non-coating portion where the metal sheet is exposed without the coating portion; and
an insulating coating portion provided at a boundary between the coating portion and the non-coating portion to cover at least a portion of the coating portion,
wherein the electrode sheet inspection system determines whether the insulating coating portion is defective.

11. A method of inspecting an electrode sheet using an electrode sheet inspection system according to claim 1, the method comprising:
performing insulating coating measurement step, in which an electrode sheet is carries while being equipped with an insulating coating portion, and the insulating coating portion of the electrode sheet is measured using a measurer to obtain an image; and
performing an insulating coating determination step, in which the image is analyzed to determine whether the insulating coating portion is defective,
wherein the measurer comprises:
first and second lighters provided on the upper side of the electrode sheet and irradiating light onto the electrode sheet;
a third lighter provided adjacent to a side of the electrode sheet and irradiating light onto the electrode sheet; and
an imager provided on the upper side of the electrode sheet and imaging the electrode sheet and transmitting the image to the controller.

12. The method of claim 11,
wherein the imager is provided at an angle of 40 ° to 65 ° with respect to the electrode sheet, and acquires an image by light irradiated by each of the first to third lighters.

13. The method of claim 11,
further comprising, prior to the performing of the insulating coating measurement step, performing electrode sheet path detection step in which the carrying path of the electrode sheet is measured,
wherein the electrode sheet path detection step comprises
measuring the carrying path of the electrode sheet using a detection sensor, and transmitting to a controller if the carrying path measured by the detection sensor deviates from a pre-input range by a first distance, wherein the controller adjusts the position of at least one of the first, second, or third lighters and the imager.

14. The method of claim 11,
further comprising, after the performing of the insulating coating determination step, performing defect position display step in which the bonding position of the electrode sheet is displayed,
wherein the defect position display step comprises
displaying the defect position on the electrode sheet if the insulating coating portion is determined to be defective in the insulating coating determination step.

15. The method of claim 11,
further comprising performing electrode sheet path detection step in which the carrying path of the electrode sheet is measured before the insulating coating measurement step;
and performing defect position display step in which the bonding position of the electrode sheet is indicated after the insulating coating determination step,
wherein the electrode sheet path detection step, the insulating coating measurement step, the insulating coating determination step, and the defect position display step are performed in-line.
